(19) United States
(12) Patent Application Publication
(10) Pub. No.: US 2018/0285758 A1
(43) Pub. Date: Oct. 4, 2018

(54) METHODS FOR CREATING AND ANALYZING DYNAMIC TRAIL NETWORKS

(71) Applicant: CARNEGIE MELLON UNIVERSITY, Pittsburgh, PA (US)

(72) Inventor: Kathleen Carley, Pittsburgh, PA (US)

(21) Appl. No.: 15/945,321

(22) Filed: Apr. 4, 2018

Related U.S. Application Data
(60) Provisional application No. 62/601,913, filed on Apr. 4, 2017.

(51) Int. Cl. G06N 7/00; G06F 17/30

(52) U.S. Cl. CPC G06N 7/005; G06F 17/30979; G06F 17/30371

(57) ABSTRACT

A system for creating a dynamic trail network from temporal sequence data, the network consisting of nodes representing locations and edges representing the probability of movement from one node to another by an entity. The network captures trails traveled by entities as they move form node to node.

### RELATED APPLICATIONS

This application claims the benefit of U.S. Provisional Patent Application Ser. No. 62/601,913, filed Apr. 4, 2017.

### GOVERNMENT INTEREST

This invention was made with government support under N00014-15-1-2563 awarded by the Office of Naval Research. The government has certain rights in the invention.

### BACKGROUND OF THE INVENTION

Forecasting requires understanding the order in which events are likely to unfold. Currently, it is difficult to tell how people will move between various life options or services, or how ideas will move between groups, cities or countries. At the physical level, the physical geography and the built environment constrain the movement of people and objects. This results in a need for route planning. However, at the organizational, social and cultural level, there are fewer physical constraints. As such, movement may be impacted by other factors, such as norms, preferences, and social networks.

As an example, a visit to a doctor may result in a number of referrals. Which referral should be followed-up first? In part, the order in which the referrals will be followed-up is a matter of convenience, preference, pressure from a social network about what to attend to, and so on. As another example, activists may try to get people interested in a particular cause—such as the occupy movement, or the anti-gun movement, or the wave of revolutions in the Middle East. In such cases, a class of events such as protests over civil rights, can move from one community to another.

Normative and economic pressures may also play a role. As another example, a scientific idea such as “complexity” may start in one field, and then flow to others—creating wide spread shifts in science. In such cases, the ideas move through fields as papers are presented at conferences and published in journals. Scientific and social networks play a key role. As another example, a ball may move between players on a team. In such a case, games and strategies for winning can be assessed from a network perspective in terms of this movement.

These examples illustrate the role of socio-cultural, physical and cognitive factors in effecting the movement of people, events, ideas and objects through complex socio-cultural and physical systems. If the trail of a person, event, idea or object through these complex systems could be tracked, and if this could be done for a large enough number of people, that information could form the basis of a predictive model for illuminating where a person, event, idea or object was likely to move, given a current location. Such trail/prediction problems are ubiquitous in the socio-cultural and physical space.

Network analysis is a non-linear technique that measures relationship interdependencies in complex systems that traditional statistical methods cannot capture. The method combines mathematics, statistics, computer science and social science to detect and interpret patterns in relational data. In prior art systems, a node in a network can represent any discrete entity, such as an individual, event, idea or object. Links between nodes may indicate a relationship between the nodes that can be measured and quantified. Existing network analysis techniques, however, are missing the critical temporal, locational and directional information necessary for forecasting applications. While location information can be represented as a node, or used as a pointer to a position on a map, it cannot be used in a directional sense indicating what flows into and out of the location. It would therefore be desirable to provide a set of techniques for constructing such temporal, spatially-directed network data sets and for extracting information from the constructed networks.

### SUMMARY OF THE INVENTION

The present invention introduces a set of techniques for constructing such temporal, spatially-directed network data sets, which are hereinafter referred to as “Dynamic Trail Networks” or DTNs, and for extracting information from the constructed DTNs.

In a dynamic trail network, the nodes represent “locations” through which discreet entities move. The nodes can represent, for example, locations, which may or may not have a physical geographical analog, including but not limited to physical locations such as buildings or countries, entities serving as locations such as people or organizations, or conceptual locations such as a journal or media site.

The links between the nodes in a DTN represent the frequency with which specific temporal patterns occur in the original temporal sequence data set. The discrete entities that are moving can be any discreet entity, including, but not limited to, people, organizations, events, ideas, or objects.

The temporal dynamics can be specified using any temporal unit, including, but not limited to, nanoseconds, hours, days and years. DTNs can be instantiated with frequencies, conditional probabilities given local information, or conditional probabilities given global information. Furthermore, the resultant DTNs are inherently directional, spatially controlled, and temporally estimable.

The DTN techniques disclosed herein have multiple applications and can be used to answer important questions that competing technologies are unable to answer; e.g., what are the most likely paths between actors through which ideas move that create a cohesive sub-group? What trails are characteristic of championship sports teams? Do civil rights events move through communities in the same way that environmental consciousness events move? Can the order of service provision by a company be optimized to promote better outcomes? Many other similarly related questions are possible. The disclosed DTN techniques can be used to analyze a sequence of medical services to determine the sequence of care patterns (i.e., the paths through these services) that lead to better outcomes or more cost-effective care. They can be used to identify both critical services and critical pathways. They can also be used to analyze the paths through which ideas flow to generate more effective messaging and for improved event forecasting. Finally, they can be used to assess passing behavior in sports teams, identifying both critical players and pathways.

The prior art for using trail network analysis has significant limitations that are overcome by the techniques disclosed herein. For example, prior art trail network analysis applied to health care coordination was limited in what could be analyzed because data collected during the care process was interpreted in a straightforward way without contextual processing. Specifically, the prior art methods did not account for the potential negative impact of missing data or inaccurate data. Further, the prior art techniques for building networks from temporal sequences of data did not distinguish between two separate trails connected to the same entity versus a single trail with a long delay between two events. The techniques disclosed herein significantly improve the accuracy in the formation and analysis of trail networks by providing methods for handling missing and inaccurate data and by properly classifying trails with large gaps as two distinct trails when they satisfy specified conditions.

In addition, prior art techniques for analyzing trail networks to answer questions about the relative behaviors of different sub-groups (i.e., groups of actors with different attributes) required reprocessing the entire temporal data sequence to pull out the dynamic network frequencies of the subgroups of interest. One aspect of this invention is a method for storing the DTN such that questions about sub-groups with particular attributes can be answered quickly, without reprocessing the entire temporal data sequence. This can provide an enormous cost savings, as the temporal data sequence can be extremely large and storing all records for a long period of time can represent an expensive data storage challenge.

The present invention is a process for converting temporal sequence data into a DTN that can be used to analyze and compare different data sets and different sub-groups within one or more DTNs. The new method is sensitive to context and because of that, it offers methods for inferring missing or incorrect data and a set of techniques for comparing and identifying critical differences between such DTNs. The techniques disclosed herein also significantly improve the accuracy in the formation and analysis of DTNs by providing methods for properly classifying trails with large gaps as two distinct trails when they satisfy specified conditions. In addition, the present invention includes a methodology for comparing the trails of different sub-groups within a DTN by storing the evolving DTN in a special structure such that questions about the behaviors of particular populations can be answered without re-analyzing the temporal sequence data. Because of the above features, the present invention overcomes limitations in current social network representations and in Markov models.

The present invention can be applied across any data expressing the movement of discrete entities to different locations over time. The discrete entity can be anything, including but not limited to people, organizations, events, ideas or objects. The locations through which these discreet entities move can be any location that may or may not have a physical geographical analog, including but not limited to physical locations such as buildings or countries, entities serving as locations such as people or organizations, or conceptual locations such as a journal or media site. The temporal dynamics can be specified using any temporal unit, including, but not limited to, nanoseconds, hours, days and years. DTNs can be instantiated with frequencies, conditional probabilities given local information, or conditional probabilities given global information.

### BRIEF DESCRIPTION OF THE DRAWINGS

FIG. 1 is a component-level diagram of a system for creating DTNs in accordance with the invention.

FIG. 2 is a component-level diagram showing the temporal data sequence pre-processing component of the system.

FIG. 3 is a flow chart showing the functions of building a DTN.

FIG. 4 is a component diagram of the query engine of the present invention.

FIG. 5 shows a feature representation using a Probabilistic Finite State Automata (PFSA). Each trail is represented by a numerical feature vector, the state probability vector of the derived PFSA (the model of the generative process).

### DETAILED DESCRIPTION OF THE INVENTION

The overall invention described herein can be broken down into three main components. The present invention should cover any system that use one or more of the components described below. That is, using any one of them or any combination of them constitute practicing the invention disclosed herein.

“Smart” Creation of DTNs from Temporal Sequence Data—

The invention covers any method that calculates a DTN by taking into account the context of the discrete entities that are moving and using something in the context to represent the locations in the process of calculating the DTN. Prior art methods calculate the transition probability using only the temporal sequence without the use of any contextual information. The input from which the DTN is generated is the temporal data sequence. For example, a temporal data sequence could be a sequence of data regarding the dates and times of patient visits to medical service providers. The temporal data sequence could be a single data set containing records that provide information about the locations of discrete entities at specific times. Alternatively, it could be a continuous process in which new data about the locations of discrete entities arrives sequentially over time resulting in a dynamic temporal sequence data set. The temporal data sequence contains, at a minimum, the discrete entity, the location, and a time or date. Often, the temporal sequence data set will contain other contextual information. For example, in the case of medical records, information on the diagnosis or on the specific treatment provided might also be included in the temporal sequence data set.

One element of this invention is the use of expert knowledge about the overall process being studied to improve the quality of the generation of the DTN from the temporal sequence data. One way to implement this approach in a computational system is to create a set of rules that codify the expert knowledge about the process being studied.

To make it clearer how the above approach can improve the quality of the generated DTNs, several examples are presented next. First, expert knowledge, in the form of rules, can be used to identify “missing” temporal steps in the data sequence. There are many possible reasons that temporal data elements could be missing from a data set. As an example, one clinic might fail to report the treatment of a patient to the temporal database. The method of the present invention makes use of expert knowledge about the possible sequences of temporal locations to identify ones that are not possible. For the case of the medical example above, an example would be having a patient show up at the hospital for an x-ray without having visited either the emergency room or a doctor preceding the visit for the x-ray. This is a violation because the x-ray would have required a prescription.

In addition, expert knowledge can also indicate that certain sequences are required. This not only indicates a missing temporal location, it can also be used to fill in the temporal location using the expert knowledge.

Another example is using context to fill in erroneous entries. Again, expert knowledge can capture a range of what services are provided at what locations. In the medical case, these are usually represented as treatment codes. If the listed treatment code is incompatible with treatments performed at that temporal location, but is numerically similar (in a Hamming distance sense) to a treatment code that is compatible with that treatment location, then the treatment code can be corrected and used in generating the DTN.

A second extremely important aspect of the DTN process is identifying where the discrete entities enter and exit the overall network of trails. In the prior art, entity entrance and exit was ignored. In this invention, entry and exit points are noted and start and stop nodes are added as special locations. In essence, knowledge about the specific case being studied is used to identify when to break up one trail into two trails. This can occur repeatedly, such that there is no limit to the number of times a given trail can be broken up into shorter trails. The goal of forming the best possible DTN requires identifying gaps in the sequence of locations visited by an entity.

Examples of approaches to using expert knowledge about the underlying process for gap identification include, for example using machine learning techniques and/or subject matter expert input to identify anomalous temporal gaps in trails. If there is a long gap between two visits, either the machine learning algorithm or the expert can specify a time gap beyond which the second visit should be treated as the start of a new, independent trail, rather than as the next step in the original trail. That is, one approach is to use expert knowledge to determine the maximum time gap between events that is consistent with a single trail. Either type of expertise can be used to provide a maximum time gap value. Additional contextual accuracy can be achieved by adjusting the maximum time gap depending on the attributes of the entity, the location last visited, the location next visited, and the temporal unit. Additionally, the time gap for segmenting trails can be context dependent. For example, data can be divided up into categories and each category could have separate time gaps.

This method allows for a very accurate determination of when to break a single trail into multiple trails in generating the DTN. For example, in the medical case, a patient visits his general practitioner for a routine physical and then 6 months later visits the emergency room. As long as the patient does not have an ongoing medical condition that would routinely cause the patient to need emergency room service, these two events are likely not part of the same trail and a new trail should be started with the emergency room visit.

Categorical Incremental Storage for Rapid Calculation of DTNs by Categories—

A second inventive aspect of the system described herein is the way in which incremental data is stored. In many cases, the data set associated with the temporal data sequence is extremely large. The temporal data sequence may even be stored in a distributed fashion such that all of it is not available at any one location. In addition, an important analysis question for DTNs is how the transition frequencies of one sub-group differ from the overall population and how they differ from those of another sub-group. Because the discrete entities often have attribute data associated with them (e.g., age, ethnicity, gender, etc.), these or other properties of the discrete entity or their location sequence are often the attributes used to define sub-groups. In the medical example, sub-groups might be defined by patient attributes, by what locations they have visited or by a diagnosis that is recorded with the temporal data sequence.

The approach taken in the prior art is to store the entire temporal data sequence. Thereafter, when the DTN of a particular sub-group is needed, the entire processing of the temporal data sequence is repeated, but only entries that meet the sub-group specification of interest are used in generating the associated subgroup DTN. While this approach is practical for small temporal data sequences, it becomes very burdensome and time consuming for large temporal data sequences and extremely difficult when the temporal data sequence is stored in a distributed fashion. A key novel aspect of the concept disclosed in the present invention is to start by identifying all of the possible sub-groups (including the overall data set as a sub-group) that might be of interest. As the temporal data sequence is processed, the counts are updated for each possible transition in the DTN associated for every possible sub-group. Note that the advantage of this new approach is that while the size of the temporal data sequence continues to grow as more data is received, the size of the set of DTNs associated with every possible sub-group does not increase. Therefore, this new approach will always offer an advantage in total data storage required at any point in time as temporal data sequence size continues to grow. When analysis requires the DTN associated with any particular sub-group or set of sub-groups, it can be quickly calculated from the counts associated with the DTN for that sub-group.

DTN Clustering and Comparison Methods—

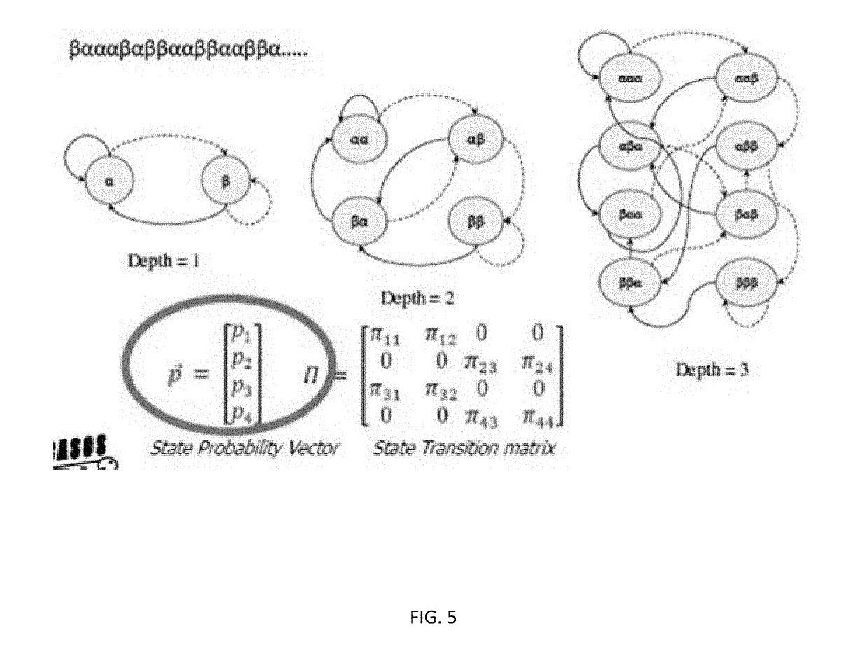

The final inventive aspect of this system is in the analysis of the DTNs. Additional information can be gleaned by analyzing discrete entities across location and time together. Therefore, the third aspect is to carry out analysis of how the discrete entities cluster in both location and time simultaneously. A specific example of how this might be done is described next. FIG. 5 shows a feature representation using a Probabilistic Finite State Automata (PFSA). Each trail is represented by a numerical feature vector, the state probability vector of the derived PFSA (the model of the generative process). For joint spatio-temporal behavior, the discrete entity trails are clustered based on their feature vectors via a 2-step process: First, a coarse clustering step is performed in which trails are initially grouped coarsely according to the locations visited, irrespective of the frequency of the visits. Second, a cluster refining step is performed (perhaps multiple times), as shown in FIG. 5, in which the coarse clusters are each clustered using agglomerative clustering to derive groups of trails which visit “similar” locations with “similar” frequencies.

Moving entities may have associated attributes. The attributes may be used to determine a context pattern to which the entity belongs, where the context consists of a set of domain-specific attributes which may form a pattern based upon the values of the attributes. Attributes not used to determine the context may be used to characterize any moving entities that do not follow the common trail associated with the context. The attributes, in addition to their use within the DTN, may also be used in secondary statistical analyses to assess differences or similarities in trails based on the attributes of the moving entity.

Sub-groups of moving entities may be created. A sub-group may be defined as a set of moving entities whose attributes match a pattern defined by the context of interest. Sub-groups may also be defined as a set of moving entities whose DTN trails are similar to each other, as determined by a grouping algorithm run on the network. Similarities may be defined in terms of the Euclidean distance between the dynamic network trails of the moving entities. Sub-groups may further be defined as a set of trails, or portions of trails that are similar.

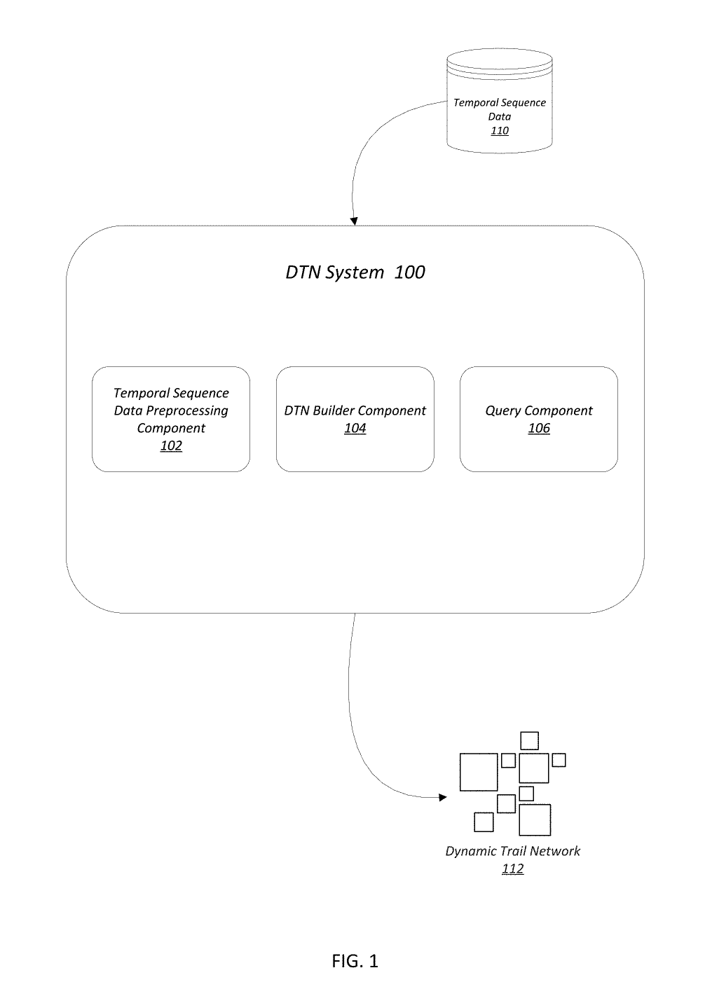

The invention may be implemented as a system via software, running on a processor, for performing the functions of creating and using the DTN. The method is shown graphically as a component-level diagram 100 in FIG. 1. The input to the process is a static or dynamic set of temporal sequence data 110 describing dates and times when discrete entities visited various locations. The overall system 100 comprises a temporal sequence data pre-processing component 102, a DTN builder component 104 and a query component 106, all of which are described in more detail below.

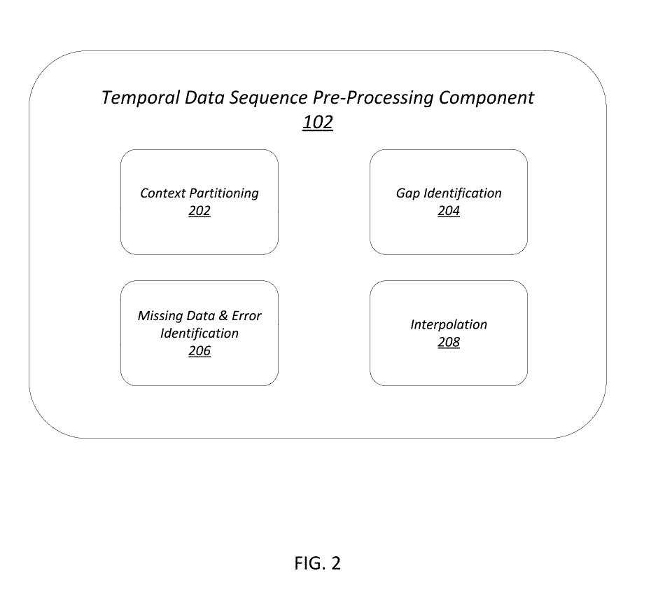

FIG. 2 is a component-level diagram showing the temporal sequence data pre-processing component 102. Temporal sequence data pre-processing component 102 performs various functions on the temporal sequence data prior to the creation of the dynamic trail network. These functions include, but are not necessarily limited to, context partitioning, gap identification, missing data and error identification, and interpolation. Each of the functions performed by the temporal sequence data pre-processing component 102 is optional and may or may not be performed for a particular temporal sequence data set.

The context partitioning component 202 partitions the temporal sequence data using context. The context consists of a set of domain-specific variables which may be identified based upon expert knowledge in the domain to which the temporal; sequence data pertains. Patterns can be identified within the context, wherein a pattern is a set of unique combinations of the values taken on by the variables. The software applies rules to extract moving entities having matching patterns and groups them (as well as their trails) into sub-groups.

Gap identification component 204 is able to identify gaps in the trails. That is, the process is capable of determining when a trail should be broken down into two or more separate trails. The determination of whether a trail should be broken into two or more separate trails may be made based upon satisfying one or the other of two specified factors. One factor is a time lag between node transitions greater than the maximum time feasible for the trail to continue. That is, the maximum feasible time between the entity entering a first location and moving from the first location to a second location. The maximum time may be determined utilizing expert knowledge in the domain and/or machine learning techniques, and implemented via a rule set. Another way to determine if the trail should be broken into separate trails is a time lag between entering a note and leaving that node for another node that is anomalous for the inter-arrival rate of moves for the moving entities in this context. This may be determined statistically using Fourier analysis, if there are enough time periods, or by using a comparison against the coefficient of variation if too few time periods are available. The rules determining the threshold for breaking a trail into two or more distinct trails are domain-specific and likely vary from one domain to another

Missing data and error identification component 206 tags and, if possible, cleans missing or erroneous data within the temporal data sequence. Domain-specific expert knowledge may be applied to improve the quality of the temporal data sequence. A set of domain-specific rules may be applied to detect anomalies within the trails. For example, specific sequences of nodes may be analyzed to detect invalid sequences and repair those sequences by adding missing nodes, or apply attributes of the discrete entities moving throughout the nodes to validate sequences.

Interpolation component 208 may infer values for missing data within the temporal data sequence. The inferences may be based on the prior activity of the moving entity or on the nearest match, given a particular context. The temporal sequence data may be updated with the inferred information.

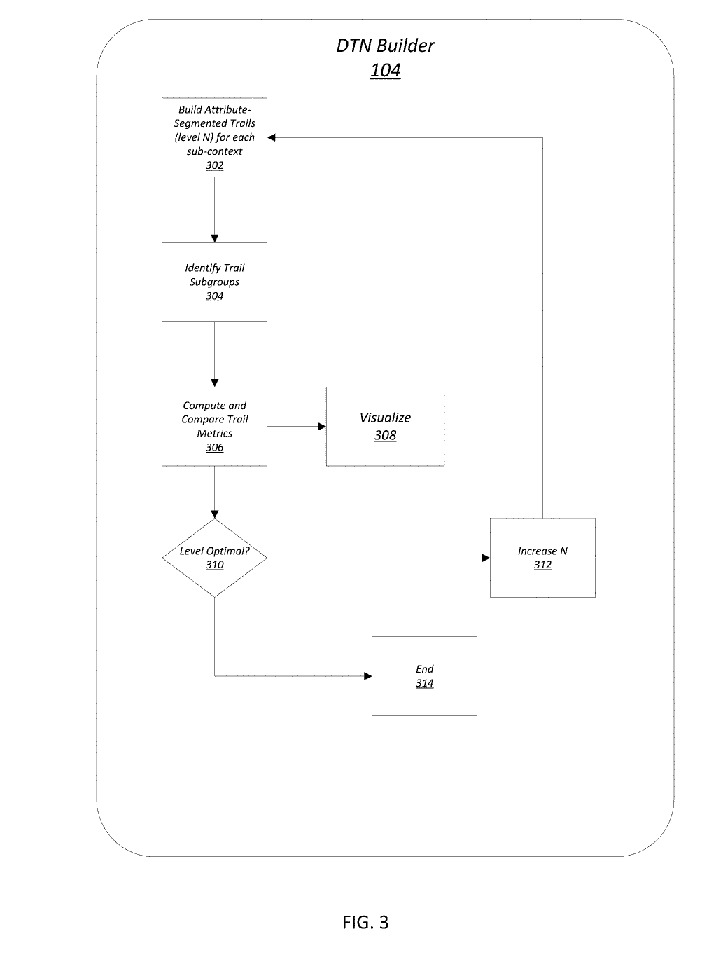

The DTM builder component 104 is a process for creating the DTN and is shown in flowchart form in FIG. 3. At 302 in FIG. 3, a Markov-like network is built from the temporal sequence data, one per moving entity and one for all entities in the context set. For each transition between a first node and a second node, a count is maintained as the data is parsed, the count representing the number of transitions from the first node to the second node. The edge probabilities between any two nodes may be calculated by summing the transitions to all other nodes leaving the first node and calculating the probability for each transition by taking the number of transitions from the first node to a second node and dividing by the count of all transitions leaving the first node. In a preferred embodiment of the invention, the N parameter is initially set to 1, indicating that each node represents a discrete location, that is, no nodes are combined.

The process has the ability to refine the DTN by combining two or more nodes into a single node. This may be appropriate, for example, when there is a high probability that a transition from a second node to a third node is preceded by a transition from a first node to the second node. In such a case, the first and second nodes may be combined into a single node representing a single location. As an example, if there are transitions between three nodes A->B->C, there may be a high probability (i.e., a probability above a predetermined threshold) that the transition from B->C is preceded by the transition from A->B. In this case, nodes A and B may be combined, such that AB->C. The depth of the clustering (i.e., the maximum number of nodes that are combined, is specified by a parameter, N) may be varied. It may be possible, for example, to combine more than two nodes in to a single node. Domain-specific knowledge may be applied to determine the optimal number of nodes and the probability threshold for combining nodes.

It should be noted that the application of the components within the temporal data sequence preprocessing component is optional. If the context partitioning component 202 is not utilized, the partition defaults to the entire temporal sequence data set. If gap identification component 204 is not utilized, the gap length is set to infinity. Likewise, if the missing data and error identification component 206 and the interpolation component 208 are not utilized, then the missing data would be set to none.

At 304, trail subgroups are identified. A trail based clustering algorithm identifies all common trails or trail segments in a context. At 306 the trail metrics are computed and compared. Dynamic network metrics are calculated on the Markov-like network that has been generated and on the common trail or trail segments. Clustering is used to partition the network. Comparisons across contexts is done by statistically comparing dynamic network trail metrics.

The network may be visualized at 308 by showing distributions for network metrics, bar charts and other visual analytics which may be used to compare similarities and differences.

At 310, it is determined if the dimension level (N) is at the optimal depth. Multi-criteria optimization accounting for processing speed, data size, and value added due to extra dimensions is used to determine the nodes in the Markov-like networks that are generated. The nodes can represent single or multiple locations. The optimal depth may be determined using a multi-criteria function based on speed to process the data, fit to data and interpretability. A comparison between dimension depth N+1 and dimension depth N may determine if the value-added is worth the speed/interpretability trade-off. The trade-offs may be domain-specific and may be set using expert knowledge in the domain. The visualization at 308 of each dimension level may be used to assist in the determination of the optimal depth value for N.

If it is determined, at 310, that the level was not optimal, the level may be increased at 312, preferably by 1, and new networks may be generated at 302. If the dimension level is found to be optimal then the process ends at 314.

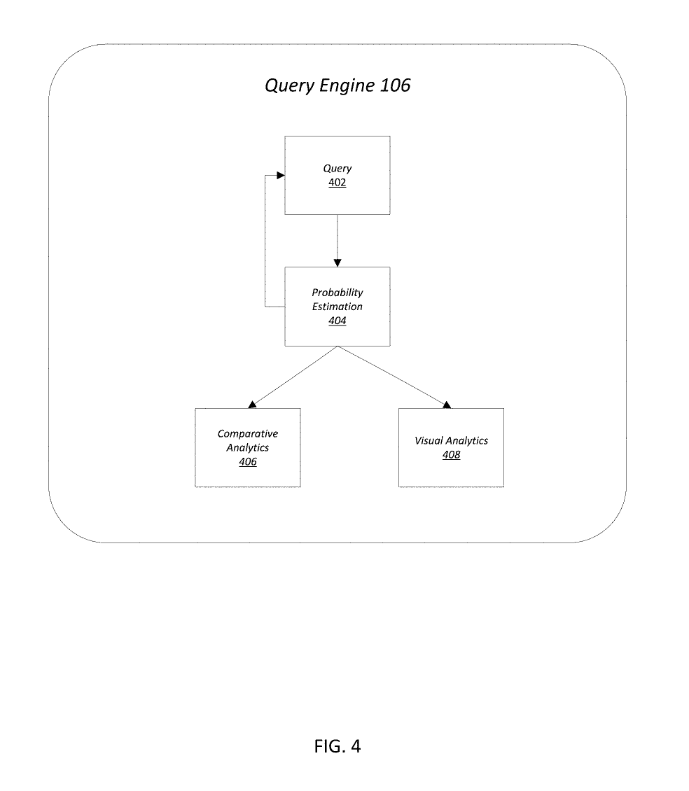

User queries may be made against the optimized DTNs. Query engine 106, shown in FIG. 1, processes the queries. FIG. 4 shows the end-user query process. At 402 a query is received from an end-user. The user specifies an interest in a context pattern or in a specific entity or location and details are provided. At 404 a probability estimation is performed. The probability estimation calculates the likelihood of a next event and/or outcome on the variable of interest which was specified in the query. Comparative analytics 406 are produced as a statistical comparison of a moving entity and the context-related group and/or a statistical comparison of trails in different contexts. Visual analytics are presented in 408 showing a visualization of the trail network of a moving entity versus that of the group and/or a visualization of a trail network for one context group versus another context group.

The invention has been explained in terms of specific implementations and architectures which one of skill in the art would realize is not meant to limit the invention. Many implementations and arrangements of components are possible without deviating from the scope of the invention.

I claim:

1. A system comprising:
a. a processor;
b. software, executing on the processor, the software implementing a DTN builder component for performing the functions of:
receiving a data set of temporal sequence data;
parsing the data set to identify a plurality of locations within the data set;
creating a network wherein nodes in the network represent locations in the data set, the nodes being having a depth indicating the maximum number of locations represented by a single node;
parsing the data set to identify a plurality of trails traveled by a plurality of discrete entities moving between the plurality of locations; and
assigning probabilities to edges between the nodes, the probabilities indicating the likelihood that an entity leaving one node will move to another node.

2. The system of claim 1 wherein assigning probabilities comprises, for each node in the network,
a. keeping a count of all entities leaving the node;
b. keeping a count of all entities leaving the node for each other node; and
c. calculating the probability by dividing the count of all entities leaving the node for each other node by the count of all entities leaving the node.

3. The system of claim 1 wherein the software performs the further function of identifying common trails or trail segments in a context.

4. The system of claim 3 wherein the software performs the further function of calculating dynamic network metrics on the identified common trail or trail segments and partitioning the network by clustering segments having a similar network metrics.

5. The system of claim 1 where the software performs the further functions of:
a. determining that the depth of the network is not optimal; and
b. rebuilding the network with a higher depth.

6. The system of claim 1 wherein the software further comprises a context partitioning component for performing the functions of:
a. partitioning the temporal sequence data based on context, the context comprising a set of domain-specific variables;
b. identifying patterns within the context, wherein a pattern is a set of unique combinations of the values taken on by the variables; and
c. applying the rules to extract moving entities having matching patterns and grouping the entities and their trails into subgroups.

7. The system of claim 1 wherein the software further comprises a gap identification component for performing the functions of:
a. applying a set of domain-specific rules to detect discontinuity in some aspect of the data associated with one or more of the discrete entities at a particular node;
b. breaking the trail into separate trails at the node where in the discontinuity was detected.

8. The system of claim 7 wherein the discontinuity is a temporal discontinuity.

9. The system of claim 7 wherein the temporal discontinuity is detected using a Fourier analysis.

10. The system of claim 7 or the temporal discontinuity may be detected using a comparison against a coefficient of variation.

11. The system of claim 7 wherein the discontinuity is detected by an analysis of one or more of attributes of the entity, a location last visited and a location next visited.

12. The system of claim 1 wherein the software further comprises a missing data and error identification component for performing the functions of:
a. identifying missing or erroneous data within the temporal sequence data set using domain-specific roles to detect anomalies; and
b. correcting missing or erroneous data within the temporal data sequence.

13. The system of claim 12 wherein they detected anomaly is an invalid sequence of movements of an entity from location to location.

14. The system of claim 12 wherein the software further comprises an interpolation component, interpolation component inferring values for missing data within the temporal data sequence.

15. The system of claim 14 wherein the inferences used in the interpolation are based on the prior activity of a moving entity or on the nearest match, given a particular context.

16. The system of claim 5 wherein the depth level is determined and not to be optimal when a probability that a transition from a first node to a second node is preceded by a transition from one or more other nodes in a particular order exceeds a predetermined threshold.

17. The system of claim 16 wherein the first node is combined with the one or more other nodes, and further wherein the probability assigned to the edge between the combined node and the second node is the probability that the second node is visited after an entity has visited the combined nodes in a particular order.

18. The system of claim 1 wherein the software includes a query component for performing the functions of:
a. accepting queries from an end-user, the query specifying a variable of interest; and
b. calculating the probability of a next event and/or outcome based on the variable of interest.

19. The system of claim 18 wherein the query component performs the further function of providing comparative analytics produced as a statistical comparison of a moving entity and the context-related group and/or a statistical comparison of trails in different contexts.

20. The system of claim 18 wherein the query component performs the further function of providing visual analytics showing a visualization of the trail network of a moving entity versus that of the group and/or a visualization of a trail network for one context group versus another context group.
